(19) United States
(12) Patent Application Publication
(10) Pub. No.: US 2024/0143092 A1
(43) Pub. Date: May 2, 2024

(54) WEARABLE ELECTRONIC DEVICE COMPRISING WHEEL

(71) Applicant: Samsung Electronics Co., Ltd., Suwon-si (KR)

(72) Inventors: Gisoo LIM, Suwon-si (KR); Seungnyun KIM, Suwon-si (KR); Dongil SON, Suwon-si (KR); Jongmin YOON, Suwon-si (KR); Seungjoo LEE, Suwon-si (KR); Kyusik CHOI, Suwon-si (KR)

(21) Appl. No.: 18/493,145

(22) Filed: Oct. 24, 2023

Related U.S. Application Data
(63) Continuation of application No. PCT/KR2023/016255, filed on Oct. 19, 2023.

(30) Foreign Application Priority Data
Oct. 28, 2022 (KR) 10-2022-0141656
Nov. 11, 2022 (KR) 10-2022-0150804

(51) Int. Cl. G06F 3/0362; G02B 27/01; G02C 5/14; G06F 3/02; G06F 3/0354

(52) U.S. Cl. CPC G06F 3/0362; G02B 27/0176; G02C 5/146; G06F 3/02; G06F 3/03547; G02B 2027/0154; G02B 2027/0178

(57) ABSTRACT

A wearable electronic device is provided. A wearable electronic device includes a housing including a lens frame accommodating a transparent member, and a wearing member having at least a portion thereof configured to move relative to the lens frame, a processor positioned inside the housing, and an input structure including a wheel configured to adjust position of the wearing member with respect to the lens frame. The processor is configured to perform a specified operation, based on a signal obtained using the input structure.

### CROSS-REFERENCE TO RELATED APPLICATION(S)

This application is a continuation application, claiming priority under § 365(c), of an International application No. PCT/KR2023/016255, filed on Oct. 19, 2023, which is based on and claims the benefit of a Korean patent application number 10-2022-0141656, filed on Oct. 28, 2022, in the Korean Intellectual Property Office, and of a Korean patent application number 10-2022-0150804, filed on Nov. 11, 2022, in the Korean Intellectual Property Office, the disclosure of each of which is incorporated by reference herein in its entirety.

### TECHNICAL FIELD

The disclosure relates to a wearable electronic device including a wheel.

### BACKGROUND ART

As electronic and communication technologies develop, electronic devices may be miniaturized and lightened to the extent that they may be used without much inconvenience even when worn on the user's body. For example, wearable electronic devices, such as head-mounted devices (HMDs), smart watches (or bands), contact lens-type devices, ring-type devices, glove-type devices, shoe-type devices, or clothing-type devices are being commercialized. Since the wearable electronic devices are directly worn on the body, portability and user accessibility thereof may be improved.

A head-mounted device is a device worn on a user's head or face and may provide augmented reality (AR) to the user. For example, a head-mounted device providing augmented reality may be implemented in the form of glasses and may provide information about objects in the form of images or text to the user in at least a part of a user's field of view. The head-mounted device may provide virtual reality (VR) to the user. For example, the head-mounted device may output an image to both eyes of the user and output content provided from an external input to the user in the form of an image or sound, thereby providing an excellent sense of immersion.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide a wearable electronic device comprising wheel.

Additional aspects will be set forth in part in the description which follows and, in part, will be apparent from the description, or may be learned by practice of the presented embodiments.

In accordance with an aspect of the disclosure, a wearable electronic device is provided. The wearable device includes a housing including a lens frame accommodating a transparent member, and a wearing member having at least a portion thereof configured to move relative to the lens frame, a processor positioned inside the housing, and an input structure including a wheel configured to adjust position of the wearing member with respect to the lens frame. The processor is configured to perform a specified operation, based on a signal obtained using the input structure.

In accordance to with another aspect of the disclosure, an electronic device is provided. The electronic device includes a housing including a lens frame and a wearing member having at least a portion thereof configured to move relative to the lens frame, a processor positioned inside the housing, a wheel configured to adjust position of the wearing member with respect to the lens frame, and-a rotation detection sensor disposed inside the wearing member and configured to detect rotation of the wheel. The wearing member includes a first area connected to the lens frame and a second area configured to move relative to the first area, based on rotation of the wheel. The wheel includes a column part connected to the first area and the second area, and a rotation area configured to rotate about the column part and transmit force to the second area. The processor is configured to perform a specified operation, based on rotation of the wheel.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an artificial reality providing system according to an embodiment of the disclosure;

FIG. 2 is a perspective view illustrating an internal configuration of an electronic device according to an embodiment of the disclosure;

FIG. 3 is a side view of an electronic device including an input structure according to an embodiment of the disclosure;

FIGS. 4A and 4B are perspective views of an electronic device including an input structure according to various embodiments of the disclosure;

FIG. 5 is a diagram illustrating length adjustment of a housing based on a wearing sensor according to an embodiment of the disclosure;

FIG. 6A is a perspective view of an electronic device including a first wheel and a second wheel according to an embodiment of the disclosure;

FIGS. 6B and 6C are diagrams illustrating an internal structure of an electronic device including a first wheel and a second wheel according to various embodiments of the disclosure;

FIG. 7A is a perspective view of an electronic device including a clutch structure according to an embodiment of the disclosure;

FIG. 7B is a cross-sectional perspective view taken along line A-A′ in FIG. 7A according to an embodiment of the disclosure;

FIG. 7C is a cross-sectional perspective view taken along line B-B′ in FIG. 7A in a first state according to an embodiment of the disclosure;

FIG. 7D is a cross-sectional perspective view along line B-B′ in FIG. 7A in a second state according to an embodiment of the disclosure;

FIG. 8 is a cross-sectional perspective view of an electronic device including a motor module according to an embodiment of the disclosure;

FIG. 9 is a perspective view of an electronic device including a touch pad structure according to an embodiment of the disclosure;

FIG. 10A is an enlarged view of an electronic device including a touch pad structure according to an embodiment of the disclosure;

FIG. 10B is a cross-sectional perspective view of an electronic device including a touch pad structure according to an embodiment of the disclosure; and

FIGS. 11A and 11B are diagrams illustrating the operation of an electronic device including an input structure according to various embodiments of the disclosure.

The same reference numerals are used to represent the same elements throughout the drawings.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

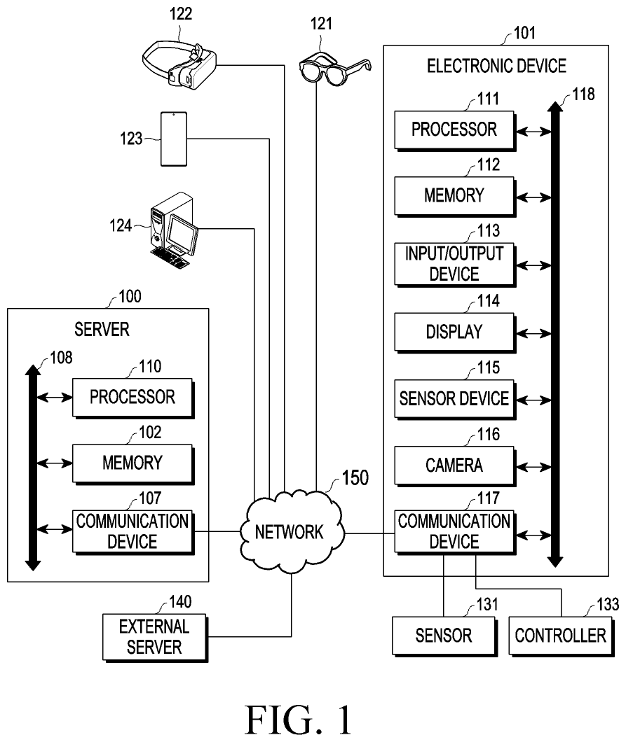

FIG. 1 is a diagram illustrating an artificial reality providing system according to an embodiment of the disclosure.

Referring to FIG. 1, the artificial reality providing system may include at least one of a metaverse server 100, an electronic device 101, at least one external electronic device 121, 122, 123, or 124, or an external server 140.

According to an embodiment of the disclosure, the metaverse server 100 may produce data for representing artificial reality (e.g., at least one of an augmented reality environment or a virtual reality environment). The metaverse server 100 may provide content capable of enhancing user immersion, in addition to augmented reality or virtual reality, and such content may be referred to as content for the metaverse. The metaverse server 100 may include a processor 110, a memory 102, and/or a communication device 107. Meanwhile, the configuration in which the metaverse server 100 includes the processor 110, the memory 102, and/or the communication device 107 is merely provided by way of example, and at least some of the operations of the metaverse server 100 may be implemented by cloud servers. The metaverse server 100 may be implemented as a distributed server, and those skilled in the art will understand that the implementation form of the server is not specifically limited.

According to an embodiment of the disclosure, the processor 110 may execute commands (or instructions) included in a program (or application) stored in the memory 102. The processor 110 may include, for example, a central processing unit (CPU), a graphics processing unit (GPU), a neural processing unit (NPU), a tensor processing unit (TPU), a digital signal processor (DSP), and an application-specific integrated circuit (ASIC), a field programmable gate array (FPGA), and/or a programmable logic device, but is not specifically limited as long as it is able to execute programs (or instructions or commands). The processor 110 may execute a program for artificial reality. A program for artificial reality may be stored in the memory 102. According to an embodiment of the disclosure, the memory 102 may include volatile memory and/or non-volatile memory, such as a hard disk storage, a random access memory (RAM), a read-only memory (ROM), and/or flash memory, but these are only examples, and the memory is not specifically limited. A program for artificial reality may be a program for a server and cause, for example, producing data for expressing artificial reality, providing produced data, identifying user input, and/or producing and providing data for expressing artificial reality updated based on the identified user input, and may include commands (or instructions) corresponding to at least some of the operations performed by the metaverse server 100 of the disclosure. The communication device 107 may support establishment of a communication channel between the metaverse server 100 and the electronic device 101 through a network 150 and communication through the established communication channel. The communication device 107 may be a device capable of providing a wide area network (e.g., the Internet), but is not limited thereto. The operation performed by the metaverse server 100 may be performed by, for example, the processor 110 or other hardware under the control of the processor 110. Commands (or instructions) that cause the metaverse server 100 to perform operations may be stored in the memory 102. The processor 110, the memory 102, and/or the communication device 107 may transmit/receive data through a bus 108 (or communication interface or network) of the metaverse server 100.

According to an embodiment of the disclosure, the electronic device 101 may perform at least one operation for expressing artificial reality (e.g., it may include providing visual content (e.g., images), providing auditory content (e.g., voice), providing tactile content (e.g., vibration), and/or providing olfactory content (e.g., smell), but is not limited to) using data for expressing artificial reality. A user who owns or wears the electronic device 101 may experience artificial reality, based on content provided from the electronic device 101. The electronic device 101 may include at least one of a processor 111, a memory 112, an input/output device 113, a display 114, a sensor device 115, a camera 116, or a communication device 117. The processor 111 may include, for example, a CPU, GPU, NPU, TPU, DSP, ASIC, FPGA, and/or programmable logic device, but is not limited as long as it is able to execute programs (or instructions or commands). For example, the processor 111 may execute a program for artificial reality. The program for artificial reality is a program for a client and may cause, for example, receiving data for expressing artificial reality from the metaverse server 100, at least one operation for expressing artificial reality (e.g., it may include providing visual content (e.g., images), providing auditory content (e.g., voice), providing tactile content (e.g., vibration), and/or providing olfactory content (e.g., smell) but is not limited to) based on the received data, identifying a user input, and/or transmission of a user input (or a command corresponding to a user input) to the metaverse server 100, and include commands (or instructions) corresponding to at least some of the operations performed by the electronic device 101 of the disclosure. According to an embodiment of the disclosure, the memory 112 may include volatile memory and/or non-volatile memory, such as a hard disk storage, a RAM, a ROM, and/or a flash memory, but these are only examples, and the memory is not specifically limited. According to an embodiment of the disclosure, the input/output device 113 may include a touch pad, a button, a mouse, a digital pen and/or a microphone, but is not specifically limited as long as it is a device for receiving (or sensing) a user input. For example, a touch screen panel, which is an example of the input/output device 113, may be integrally implemented with the display 114. The input/output device 113 may include a speaker, a haptic module, and/or a light-emitting module, but is not specifically limited as long as it is a device for outputting content related to artificial reality. According to an embodiment of the disclosure, the sensor device 115 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor. According to an embodiment of the disclosure, the camera 116 may include one or more lenses, image sensors, image signal processors, or flashes. According to an embodiment of the disclosure, the communication device 117 may support establishment of a communication channel between the metaverse server 100 and the electronic device 101 through a network 150, and communication through the established communication channel. The communication device 117 may be a device capable of providing a wide area network (e.g., the Internet) but is not limited thereto. The communication device 117 may support wired communication and/or wireless communication. For example, the communication device 117 may support short-range communication (e.g., short-range communication, such as Bluetooth, wireless fidelity (WiFi) direct, or infrared data association (IrDA)). The communication device 117 may transmit/receive data to/from the external sensor 131 and/or the external controller 133, based on short-range communication. For example, in the case where the electronic device 101 is implemented as a stand-alone type, the communication device 117 may support a function of wirelessly accessing the network 150. The communication device 117 may support cellular communication, such as long term evolution (LTE), fifth-generation (5G), and sixth-generation (6G), and/or support Institute of Electrical and Electronics Engineers (IEEE) 802 series-based communication (e.g., it may be referred to as Wi-fi). The communication device 117 may be implemented to support wired communication, and the implementation method is not limited. In the case where the electronic device 101 is implemented as a non-standalone type, the electronic device 101 may communicate with the metaverse server 100 through a relay device connectable to the network 150. For example, the communication device 117 may support short-range communication, such as Bluetooth, wireless fidelity (WiFi) direct, or infrared data association (IrDA), and communicate with the metaverse server 100 through a relay device using short-range communication. The external sensors 131 may include a gesture sensor, a gyro sensor, an atmospheric pressure sensor, a magnetic sensor, an acceleration sensor, a grip sensor, a proximity sensor, a color sensor, an IR sensor, a biometric sensor, a temperature sensor, a humidity sensor, and/or an illuminance sensor. The operations performed by the electronic device 101 may be performed by, for example, the processor 111 or other hardware under the control of the processor 111. Commands (or instructions) that cause the electronic device 101 to perform operations may be stored in the memory 112. The processor 111, the memory 112, the input/output device 113, the display 114, the sensor device 115, the camera 116, and/or the communication device 117 may transmit/receive data through a bus 118 (or communication interface or network) of the electronic device 101. The metaverse server 100 and the electronic device 101 may transmit and receive at least some data based on the web

According to an embodiment of the disclosure, the external sensor 131 may be, for example, a ring-type device, a bracelet-type device, or a head-mounted device, but the type and/or user body part to which the device is to be attached are not limited. The external sensor 131 may provide sensing data to the electronic device 101, based on short-range communication. The controller 133 may include, for example, a touch pad, a button, a mouse, a digital pen, and/or a microphone, but is not limited as long as it is a device for receiving (or sensing) a user input. The controller 133 may provide data obtained based on short-range communication to the electronic device 101. In an embodiment of the disclosure, the controller 133 may further include at least one sensor in addition to a device for receiving a user input. For example, the controller 133 may provide data associated with a user input and/or sensing data to the electronic device 101, based on short-range communication.

According to an embodiment of the disclosure, the metaverse server 100 may transmit and receive data to and from at least one external electronic device 121, 122, 123, or 124. The metaverse server 100 may transmit, to the electronic device 101, data for expressing artificial reality updated and/or changed based on the data with at least one external electronic device 121, 122, 123, or 124. The electronic device 101 may perform at least one operation for expressing artificial reality, based on data. Accordingly, if there is a plurality of users in one artificial reality, the artificial reality reflecting an operation by one user may be provided to other users.

According to an embodiment of the disclosure, the external server 140 may transmit and receive data through the metaverse server 100 and the network 150. The external sensor 131 may be, for example, a server that supports the same application (or the same artificial reality) as the metaverse server 100. Alternatively, the external server 140 may be a server that supports a different application (or different artificial reality) from the metaverse server 100. For example, the metaverse server 100 may convert the data of the external server 140 into the format of an application (or artificial reality) supported by the metaverse server 100. The metaverse server 100 may transmit data for expressing artificial reality reflecting the converted data to the electronic device 101. As described above, the metaverse server 100 may also interact with artificial reality different from the supported artificial reality, and this function may be referred to as a multiverse function.

According to an embodiment of the disclosure, the electronic device 101 may be a smart phone connectable to a head-mounted device (HMD) or a structure, which may be fixed to the head, supporting virtual reality. The user may respectively observe an image for the left eye and an image for the right eye, which are displayed on the display 114 for expressing virtual reality, with both eyes while wearing the HMD on the head or wearing the structure connected to a smartphone on the head. Alternatively, the user may observe an image for expressing virtual reality displayed on the display 114 of the electronic device 101 without wearing the electronic device 101 on the head. For example, the electronic device 101 may be implemented as a smartphone, a tablet, a general-purpose computer, or a smart mirror, but is not limited thereto.

According to an embodiment of the disclosure, the metaverse server 100 may produce data for expressing at least one space (or a scene gazing at that space) of virtual reality. For example, the metaverse server 100 may receive information of a first user (e.g., account information and/or authentication information of a first user) from the electronic device 101. The metaverse server 100 may perform a login procedure of the first user based on the information of the first user. The metaverse server 100 may identify a space corresponding to the first user from virtual reality. For example, the metaverse server 100 may identify a space allocated privately to the first user. For example, the metaverse server 100 may identify a space corresponding to the location of the first user from among open spaces. For example, the metaverse server 100 may identify a space corresponding to a user input. The method for the metaverse server 100 to identify-a space corresponding to the location of the first user is not specifically limited. For example, an avatar (or character) corresponding to at least one object and/or user may be included in the identified space. In the case where the viewpoint of a scene is a first-person viewpoint, the data for expression may be related to a scene in which the identified space is viewed from the user's viewpoint. In some cases, the scene in which the identified space is viewed may not include an avatar (or character) corresponding to the first user or may include only a part of the body (e.g., a hand, or the like), but is not limited thereto, or may include the back view of the avatar. In the case where the viewpoint of a scene is a third-person viewpoint, the data for expression may be related to a scene in which a space including an avatar (or character) corresponding to the user is viewed in one direction.

According to an embodiment of the disclosure, the scene viewed from the user's viewpoint may include avatars corresponding to other users. For example, a second user may access the metaverse server 100 using the external electronic device 122. The metaverse server 100 may produce data for expressing artificial reality that is used together by the first user and the second user. For example, if both the first user and the second user exist in a specific space, the metaverse server 100 may produce data for expressing artificial reality used together by the first user and the second user. For example, in the case where the viewpoint of a scene is a first-person viewpoint, a scene for the first user may include at least a part of the avatar of the second user. For example, when the viewpoint of a scene is a third-person viewpoint, a scene for the first user may include at least a part of a first avatar (or may be referred to as a character) corresponding to the first user and/or at least a part of a second avatar (or character) corresponding to the second user. In an embodiment of the disclosure, at least a portion of the screen displayed on the electronic device 101 may be provided to the metaverse server 100. At least a portion of the screen displayed on the electronic device 101 (or an object corresponding to at least a portion) may be disposed in the virtual reality space.

According to an embodiment of the disclosure, the metaverse server 100 may receive a user input and/or a command corresponding to the user input from the electronic device 101. For example, the electronic device 101 may identify a user input through the input/output device 113. For example, the electronic device 101 may identify a user input through the built-in sensor device 115. For example, the electronic device 101 may obtain a user input from the external sensor 131 and/or the controller 133 connected through the communication device 117. The processor 111 may identify motion information of the electronic device 101 as a user input, based on the sensing data identified through the sensor device 115. For example, the electronic device 101 may obtain a user input from the external sensor 131 and/or the controller 133 connected through the communication device 117.

According to an embodiment of the disclosure, the electronic device 101 may identify commands, based on a user input. The commands may include, for example, but are not limited to, moving within virtual reality, specifying objects within virtual reality, manipulating objects within virtual reality, and/or interacting with other avatars. The electronic device 101 may transmit the command to the metaverse server 100. For example, the electronic device 101 may transmit a user input to the metaverse server 100, instead of identifying a command based on the user input, and for example, the metaverse server 100 may identify the command, based on the user input.

According to an embodiment of the disclosure, the metaverse server 100 may update a virtual reality space or change the same to another space, based on the command. For example, if the command is specifying an object, the space may be updated to reflect a function linked to the specified object. For example, if the command is manipulating an object, the space may be updated such that the location of the object is changed. For example, if the command is performing an action of an avatar, the space may be updated such that the user's avatar performs a corresponding reaction. For example, if the command is interacting with another avatar, the space may be updated such that the avatar performs a corresponding reaction. For example, when the command is moving, the space for display may be changed into another space. Those skilled in the art may understand that there are no limitations on spatial updates and/or changes in virtual reality based on commands. The metaverse server 100 may provide auditory content, tactile content, and/or olfactory content, as well as updating and/or changing visual content. The metaverse server 100 may relay voice data and/or text for chatting between users. For example, the metaverse server 100 may update and/or change a space using correlation information between commands, updates, and/or changes. For example, the metaverse server 100 may store an artificial intelligence model that receives a user input and/or command as an input value and outputs an update and/or change of space as an output value. The metaverse server 100 may update and/or change the space, based on the output value of the artificial intelligence model. For example, the metaverse server 100 may store an artificial intelligence model that provides update and/or change of a space, based on the context of the space, without user input. The metaverse server 100 may update and/or change the space, based on the context of the space, using an artificial intelligence model.

According to an embodiment of the disclosure the metaverse server 100 may transmit data for expressing an updated space and/or data for expressing a changed space to the electronic device 101. The metaverse server 100 may transmit data for expressing an updated space and/or data for expressing a changed space to the external electronic device 122 corresponding to the second user. Accordingly, virtual reality reflecting the space updated by the first user of the electronic device 101 may be displayed on the external electronic device 122. In addition, based on information (e.g., user input and/or commands) transmitted from the external electronic device 122 to the metaverse server 100, the metaverse server 100 may update the space used both by the first user and by the second user (or the space in which both the first user and the second user exist). The metaverse server 100 may transmit data for expressing the updated space to the electronic device 101. The electronic device 101 may express an updated space, based on the received data. As described above, the metaverse server 100 may share the space updated corresponding to any one user with the electronic device of another user corresponding to the space. For example, updating and/or changing a time-sequential space may be referred to as a user experience. The metaverse server 100 and/or the electronic device 101 may store at least one piece of data related to the user experience in the memories 102 and/or 112. For example, the metaverse server 100 may store at least one piece of data related to user experience for each user (e.g., each user account). For example, the metaverse server 100 and/or the electronic device 101 may store data for expression of a point in time among the user experiences in the memories 102 and/or 112. For the convenience of explanation, this may be expressed as performing capture of user experience. The metaverse server 100 may store data related to user experience, which may be referred to as life logging. The metaverse server 100 may further store data associated with the user. For example, the metaverse server 100 may receive at least one piece of sensing data from the electronic device 101 and store the same time-sequentially or update a final value. The metaverse server 100 may produce a user (e.g., avatar) in virtual reality corresponding to the user in the real world, based on at least one piece of sensing data, which may be referred to as a digital twin.

According to an embodiment of the disclosure, the electronic device 101 may provide content for augmented reality expressing at least one visual object that may be viewed to be superimposed on a real environment viewed by a specific user. Meanwhile, those skilled in the art will understand that at least some of the operations of the metaverse server 100 and/or electronic device 101 described in the embodiment for virtual reality may also be performed by the metaverse server 100 and/or the electronic device 101 described in the embodiment for augmented reality and vice versa. According to an embodiment of the disclosure, the electronic device 101 may be a glasses-type electronic device supporting augmented reality, a smart lens, or a smartphone capable of displaying captured images in real time. The user may observe visual objects displayed on a transparent display (or semi-transparent display) of a glasses-type electronic device or smart lens together with a real environment while wearing the glasses-type electronic device or smart lens. Alternatively, the user may observe an image captured by the smartphone and a visual object displayed to be superimposed on the image.

According to an embodiment of the disclosure, the electronic device 101 may obtain a foreground image through the camera 116 (e.g., a camera facing forward). The electronic device 101 may transmit the foreground image, part of the foreground image, or 3D modeling data obtained based on the foreground image to the metaverse server 100 through the communication device 117. The electronic device 101 may identify the orientation of the electronic device 101, based on the captured image and/or data detected by the sensor device 115. The electronic device 101 may transmit data about the orientation of the electronic device 101 through the communication device 117. The electronic device 101 may obtain a photographed image of the user's eyes using the camera 116 (e.g., a camera facing backwards). The electronic device 101 may identify the user's gaze, based on the photographed image of the eyes. The electronic device 101 may transmit data on the user's gaze through the communication device 117.

According to an embodiment of the disclosure, the metaverse server 100 may produce, as data for expressing artificial reality, data for expressing at least one visual object that may be viewed to be superimposed on a real environment viewed by a specific user. For example, the metaverse server 100 may analyzed at a (data related to the foreground image, the orientation of the electronic device 101, and/or the user's gaze) received from the electronic device 101 and, based on the analysis result, identify at least one visual object. The metaverse server 100 may transmit data for expressing at least one visual object to the electronic device 101 through the communication device 107. At least one visual object may be displayed by, for example, the display 114 of the electronic device 101, and the user may observe at least one visual object superimposed on the real environment. For example, a visual object may have information and/or a form associated with an object disposed in the real environment. For example, the electronic device 101 may display a visual object such that the visual object may be observed by a user as being located near the object disposed in the real environment.

According to an embodiment of the disclosure, the electronic device 101 may identify a user input. For example, a user input may be identified through the input/output device 113 included in the electronic device 101 and/or through the external sensor 131 and/or the controller 133. The user input may cause, for example, specifying and/or manipulating visual objects to be displayed. The electronic device 101 may transmit a user input and/or a command corresponding to the user input to the metaverse server 100. The metaverse server 100 may produce data for expressing artificial reality, based on the user input and/or the command corresponding to the user input. For example, the metaverse server 100 may identify that the user input is based on specifying and/or manipulating a visual object, and perform, according thereto, transforming the visual object, moving the visual object, and/or providing another visual object corresponding to a function of the visual object, but the performed operations are not specifically limited. The metaverse server 100 may transmit data for expressing artificial reality produced based on the user input and/or the command corresponding to the user input to the electronic device 101. The electronic device 101 may provide content related to artificial reality, based on the data for expressing artificial reality. As described above, the metaverse server 100 and/or the electronic device 101 may provide a function for the user to interact with visual objects.

In an embodiment of the disclosure, the metaverse server 100 may produce, as data for expressing artificial reality, avatars (or characters) corresponding to other users. The metaverse server 100 may transmit avatars (or characters) corresponding to other users to the electronic device 101. The electronic device 101 may display the avatars (or characters) corresponding to other users using the received data for expressing artificial reality. Accordingly, the user may observe avatars (or characters) corresponding to other users to be superimposed on the real environment. Accordingly, the user may experience as if the avatars (or characters) corresponding to other users-are located in the real environment. The avatars (or characters) corresponding to other users may be manipulated by user inputs obtained from, for example, the external electronic devices 121, 122, 123, and 124, and/or may be manipulated based on an artificial intelligence model stored in the metaverse server 100, and there are no restrictions on how to manipulate the avatars (or characters). Based on the manipulation of the avatars (or characters), the metaverse server 100 may transmit data for expressing the manipulated avatars (or characters) to the electronic device 101. The electronic device 101 may express the manipulated avatars (or characters), based on the received data, and accordingly, the user may experience as if the avatars (or characters) corresponding to other users operate in the real environment. As described above, the metaverse server 100 and/or the electronic device 101 may store user experiences associated with augmented reality in the memories 102 and/or 112. For example, the metaverse server 100 may store at least one piece of data associated with a user experience in relation to augmented reality for each user (e.g., each user account). For example, the metaverse server 100 and/or the electronic device 101 may store, in the memories 102 and/or 112, data for expression of a point in time among user experiences associated with augmented reality.

Meanwhile, producing and expressing the data for artificial reality by the metaverse server 100 and the electronic device 101 is described by way of example. According to an embodiment of the disclosure, the electronic device 101 may produce data for expressing artificial reality and/or produce data for artificial reality based on data from the external electronic devices 121, 122, 123, and 124. For example, the electronic device 101 may produce data for expressing artificial reality without data from the metaverse server 100.

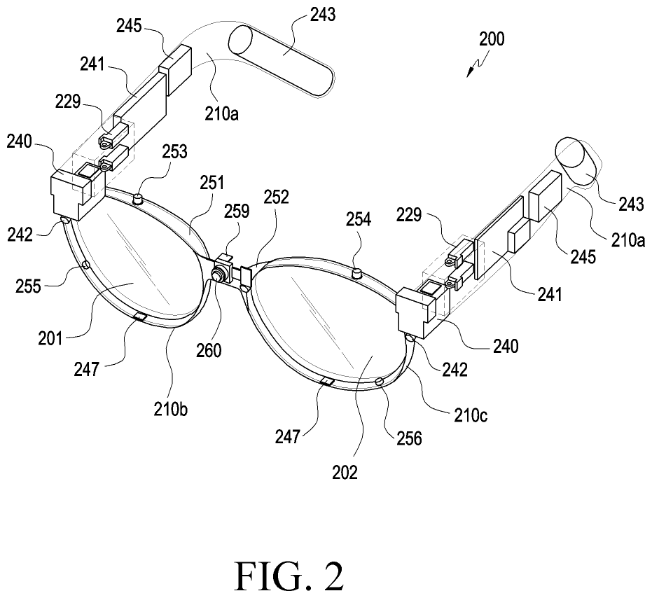

FIG. 2 is a perspective view illustrating an internal configuration of an electronic device according to an embodiment of the disclosure.

Referring to FIG. 2, an electronic device 200 according to an embodiment may include components that are accommodated in housings 210a, 210b, and 210c, disposed on the housings 210a, 210b, and 210c, and/or exposed through openings formed in the housings 210a, 210b, and 210c. The electronic device 200 in FIG. 2 may be the electronic device 101 and/or the external electronic device 121 in the artificial reality system in FIG. 1.

According to an embodiment of the disclosure, the electronic device 200 may obtain a visual image of an object or environment in a direction (e.g., the −Y direction) in which a user views or the electronic device 200 is directed using a plurality of camera modules 253, 254, 255, and 256. The camera modules 253 and 254 may be disposed on relatively upper portions of the housings 210b and 210c. Alternatively, the camera modules 253 and 254 may be exposed through openings formed in the housings 210b and 210c. The camera modules 253 and 254 may capture images corresponding to a field of view (FOV) based on at least one point of the housings 210b and 210c, for example, a field of view (FOV) corresponding to relatively upper portions when the user wears the electronic device 200. The images obtained by the camera modules 253 and 254 may be used, for example, in simultaneous localization and mapping (SLAM) and/or 6DoF, or may be used in recognition and/or tracking of a subject. The images obtained by the camera modules 253 and 254 may also be used for head tracking.

According to an embodiment of the disclosure, the camera modules 255 and 256 may be disposed on relatively lower portions of the housings 210b and 210c. Alternatively, the camera modules 255 and 256 may be exposed through openings formed in the housings 210b and 210c. Here, the upper portions corresponding to the camera modules 253 and 254 and the lower portions corresponding to the camera modules 255 and 256 are defined when the user wears the electronic device 200, and those skilled in the art will understand that a portion relatively close to the ground is referred to as a lower portion and that a portion relatively far from the ground is referred to as an upper part, which are only for convenience of description. The camera modules 255 and 256 may capture images corresponding to a FOV based on at least one point of the housings 210b and 210c, for example, a FOV corresponding to relatively lower portions when the user wears the electronic device 200. The images obtained by the camera modules 255 and 256 may be used in recognition and/or tracking of a subject. For example, the images obtained by the camera modules 255 and 256 may be used for recognition and/or tracking of a subject disposed relatively lower than a portion corresponding to the head, for example, the user's hands, when the user wears the electronic device 200, but are not limited to.

According to an embodiment of the disclosure, the electronic device 200 may perform recognition and/or tracking of a subject using at least one image captured by the camera modules 253, 254, 255, and 256. The electronic device 200 may perform an operation identified based on a result of recognition and/or tracking and, for example, provide a visual object at a location corresponding to the subject, but the operation is not limited thereto. For example, when a virtual keyboard is provided by the electronic device 200, keys specified on the virtual keyboard may be recognized based on a result of tracking the user's hand. The operation corresponding to the recognition and/or tracking result may be performed, for example, only by the electronic device 200, but this is an example, and the operation may be performed based on cooperation between the electronic device 200 and an external electronic device (e.g., the external electronic devices 121, 122, 123, and 124 in FIG. 1) and/or an external server (e.g., the external server 140 in FIG. 1).

According to an embodiment of the disclosure, the camera modules 253, 254, 255, and 256 are intended for 3DoF or 6DoF head tracking, hand detection, hand tracking, and/or spatial recognition, and may be, but not limited thereto, a global shutter (GS) camera and/or, and may be implemented as a rolling shutter (RS) camera.

According to an embodiment of the disclosure, the camera modules 251 and 252 are eye tracking (ET) cameras, and images captured by the camera modules 251 and 252 may be used in detection and/or tracking of pupils. For example, the position of a virtual image projected on the electronic device 200 may be determined using the captured image so as to be positioned according to the gazing direction of pupils of the wearer of the electronic device 200. The camera modules 251 and 252 may be implemented as a GS camera for detection and/or tracking of pupils, but are not limited thereto.

According to an embodiment of the disclosure, the display module 240 may include, for example, a liquid crystal display (LCD), a digital mirror device (DMD), liquid crystal on silicon (LCoS), an organic light-emitting diode (OLED), or a micro light-emitting diode (micro LED). Although not shown, in the case where the display module 240 is configured as one of the liquid crystal display, the digital mirror device, and the liquid crystal on silicon, the electronic device 200 may include a light source that emits light to a screen output area of the display module 240. In another embodiment of the disclosure, if the display module 240 is able to generate light by itself, for example, if it is configured as one of the organic light-emitting diode or the micro LED, the electronic device 200 may provide a virtual image of good quality to the user even without a separate light source. In an embodiment of the disclosure, if the display module 240 is implemented as the organic light-emitting diode or the micro LED, a light source is unnecessary, so the electronic device 200 may be lightweight. The electronic device 200 may include a display module 240, a first transparent member 201, and/or a second transparent member 202, and the user may use the electronic device 200 while wearing it on his or her face. The first transparent member 201 and/or the second transparent member 202 may be formed of a glass plate, a plastic plate, or a polymer, and may be made transparent or translucent. The transparent members (e.g., the first transparent member 201 and/or the second transparent member 202) may be referred to as display members. The optical waveguide may transfer the light produced by the display module 240 to the user's eyes. The optical waveguide may be made of glass, plastic, or polymer and include a nanopattern, for example, a polygonal or curved grating structure, formed on an inner or outer partial surface thereof. According to an embodiment of the disclosure, light incident to one end of the optical waveguide may travel inside the display optical waveguide by nanopatterns and then provided to the user. In addition, an optical waveguide configured as a free-form prism may provide incident light to the user through a reflection mirror. The optical waveguide may include at least one of at least one diffractive element (e.g., a diffractive optical element (DOE) or a holographic optical element (HOE)) or a reflective element (e.g., a reflective mirror). The optical waveguide may guide the display light emitted from a light source to the user's eyes using at least one diffractive element or reflective element included in the optical waveguide. According to various embodiments of the disclosure, the diffractive element may include an optical input member/optical output member (not shown). For example, the optical input member may indicate an input grating area, and the optical output member (not shown) may indicate an output grating area. The input grating area may serve as an input end for diffracting (or reflecting) the light output from a light source (e.g., the micro LED) to the transparent members (e.g., the first transparent member 201 and the second transparent member 202) of the screen display. The output grating area may serve as an exit that diffracts (or reflects) the light transferred to the transparent members (e.g., the first transparent member 201 and the second transparent member 202) of the waveguide to the user's eyes. According to various embodiments of the disclosure, the reflective element may include an optical total-internal-reflection element or total-internal-reflection waveguide for total internal reflection (TIR). For example, the total internal reflection is a method of inducing light and may indicate that an incident angle is controlled such that light (e.g., a virtual image) input through the input grating area is reflected 100% by one surface (e.g., a specific surface) of a waveguide so as to be transferred 100% to the output grating area. In an embodiment of the disclosure, the light emitted from the display module 240 may be guided in its path to the waveguide through the optical input member. The light travelling inside the waveguide may be guided toward the user's eyes through the optical output member. The screen display may be determined based on the light emitted toward the eyes. According to an embodiment of the disclosure, the first transparent member 201 may be disposed to face the user's right eye, and the second transparent member 202 may be disposed to face the user's left eye. According to various embodiments of the disclosure, if the display module 240 is transparent, the transparent members 201 and 202 may be disposed at positions facing the user's eyes to configure the screen display. The electronic device 200 may further include a lens. The lens may adjust the focus of a screen output to the display module 240 so as to be viewed with the user's eyes. For example, the lens may be a Fresnel lens, a Pancake lens, or a multichannel lens.

According to an embodiment of the disclosure, a circuit board 241 may include components for driving the electronic device 200. For example, the circuit board 241 may include at least one integrated circuit chip, and at least one of the electronic components (e.g., the processor 111, the memory 112, the input/output device 113, the sensor device 115, and/or the communication device 117 in FIG. 1) may be provided on the integrated circuit chip. According to an embodiment of the disclosure, the circuit board 241 may be disposed inside a wearing member and/or a lens frame of the housing 210. According to an embodiment of the disclosure, the circuit board 241 may be electrically connected to the battery 243 through a power transfer structure. According to an embodiment of the disclosure, the circuit board 241 may be connected to a flexible printed circuit board and transmit electrical signals to the electronic components (e.g., an optical output module and the camera modules 251, 252, 253, 254, 255, and 256) and a light-emitting unit of the electronic device through flexible printed circuit board. According to an embodiment of the disclosure, the circuit board 241 may include a circuit board including an interposer.

According to an embodiment of the disclosure, the battery 243 may be electrically connected to the components of the electronic device 200 through a power transfer structure and supply power to the components of the electronic device 200. According to an embodiment of the disclosure, at least a part of the battery 243 may be disposed on the wearing member.

According to an embodiment of the disclosure, a speaker module 245 may convert an electrical signal into sound. At least a part of the speaker module 245 according to an embodiment may be disposed inside the wearing member and/or lens frame of the housing 210. According to an embodiment of the disclosure, the speaker module 245 may be disposed between the circuit board 241 and the battery 243 to correspond to the user's ears. The speaker module 245 according to an embodiment may transmit auditory information to the user through low-frequency vibrations of the user's skin and bones.

According to an embodiment of the disclosure, a microphone module 247 may convert sound into an electrical signal. According to an embodiment of the disclosure, the microphone module 247 may be disposed in at least a portion of a lens frame 311 and/or the wearing member 312.

According to an embodiment of the disclosure, the electronic device 200 may recognize a user's voice and/or external sound using at least one microphone module 247. According to an embodiment of the disclosure, the electronic device 200 may distinguish between voice information and ambient noises, based on voice information and/or additional information (e.g., low-frequency vibration of the user's skin and bones) obtained through at least one microphone module. For example, the electronic device 200 may perform functions of clearly recognizing a user's voice and reduce ambient noise (e.g., noise canceling).

According to an embodiment of the disclosure, a camera module 259 may include an infrared (IR) camera module (e.g., a time-of-flight (TOF) camera or a structured light camera). For example, the IR camera may operate as at least a part of a sensor module (sensor module or Lidar sensor) for detecting a distance to a subject. According to an embodiment of the disclosure, the electronic device 101 may further include a sensor module (e.g., Lidar sensor). For example, the sensor module may include at least one of a vertical cavity surface emitting laser (VCSEL), an infrared sensor, and/or a photodiode.

An illumination LED 242 may have various uses depending on where it is attached. As an example of use, the illumination LED 242 attached to the periphery of the frame is used as an auxiliary means for facilitating gaze detection when tracking eye movements using the ET camera modules 251 and 252, and IR LEDs in infrared wavelengths are mainly used therefor. As another example of use, the illumination LED 242 may be attached adjacent to a camera module mounted around a hinge 229 connecting the frame and the temple or around a bridge connecting the frame, and may be used as a means of supplementing the ambient brightness during camera shooting. For example, the photographing camera module 260 may capture a relatively high-quality image of the foreground of the electronic device 200.

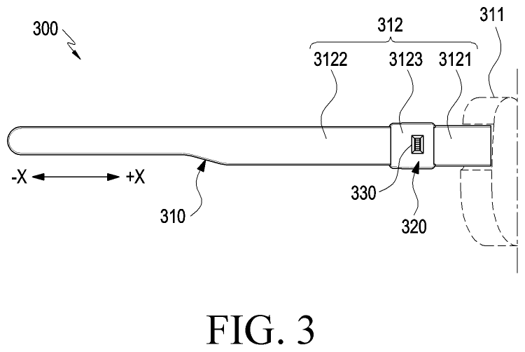

According to an embodiment of the disclosure, the shape of the electronic device 200 may be selectively designed. Although the electronic device 200 in the form of glasses is shown in FIG. 2, the shape of an electronic device 300 is not limited thereto. For example, the shape of the electronic device 200 in FIG. 3 is not specifically limited in this document as long as it is a head-mounted device (HMD) capable of being worn on the head.

FIG. 3 is a side view of an electronic device including an input structure according to an embodiment of the disclosure.

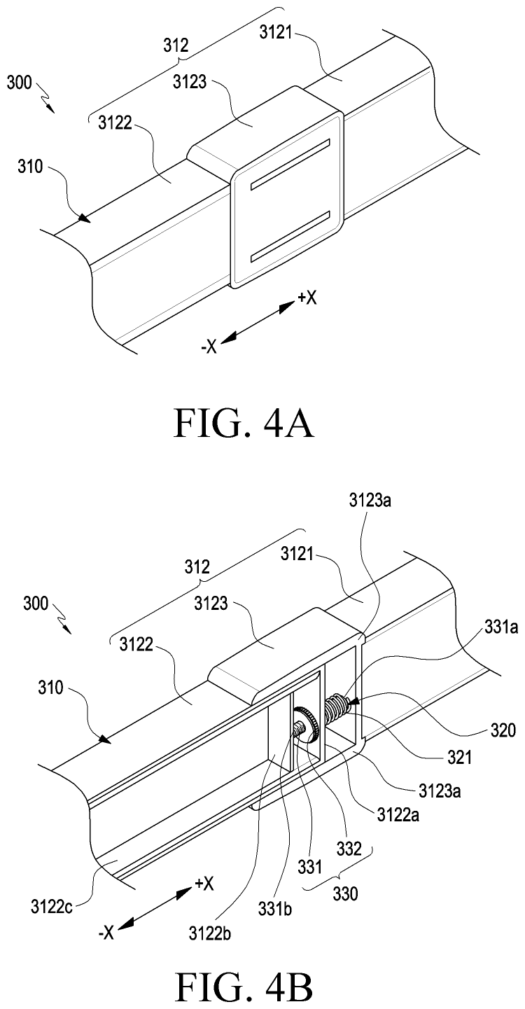

FIGS. 4A and 4B are perspective views of an electronic device including an input structure according to various embodiments of the disclosure.

Referring to FIGS. 3, 4A, and/or 4B, an electronic device 300 may include a housing 310 and an input structure 320. The configurations of the housing 310 of the electronic device 300 in FIGS. 3, 4A, and 4B may be the same as all or some of the configurations of the electronic device 200 and the housings 210a, 210b, and 210c in FIG. 2. For convenience of description, a partial structure of the electronic device 300 (e.g., a part of the housing 310) is excluded from FIG. 4B in order to describe components disposed inside the housing 310.

According to an embodiment of the disclosure, the electronic device 200 may include a housing 310 constituting an external appearance of the electronic device 200. The housing 310 may provide a space in which components of the electronic device 200 may be disposed. For example, the housing 310 may include a lens frame 311 and at least one wearing member 312. The lens frame 311 may be a part of the housing 310 accommodating a transparent member (e.g., the first transparent member 201 and/or the second transparent member 202 in FIG. 2). The wearing member 312 may be a part of the housing 310 extending from the lens frame 311.

According to an embodiment of the disclosure, the lens frame 311 may accommodate at least a part of the transparent member 201. For example, the lens frame 311 may surround at least a portion of an edge of the transparent member 201. According to an embodiment of the disclosure, the lens frame 311 may position at least one of the transparent members 201 to correspond to the user's eyes. According to an embodiment of the disclosure, the lens frame 311 may be a rim in a general eyeglasses structure.

According to an embodiment of the disclosure, the wearing member 312 may extend from the lens frame 311. For example, the wearing member 312 may extend from an end of the lens frame 311 and may be supported or positioned on the user's body (e.g., ear) together with the lens frame 311. According to an embodiment of the disclosure, the wearing member 312 may be referred to as a temple.

According to an embodiment of the disclosure, at least a portion of the wearing member 312 may move relatively to the lens frame 311. For example, at least a portion of the wearing member 312 may slide and/or rotate with respect to the lens frame 311.

According to an embodiment of the disclosure, at least a portion of the wearing member 312 may move relative to the lens frame 311 in a first direction (the +X direction) or a second direction (the −X direction), and a wheel 330 may rotate based on the first direction or the second direction.

According to an embodiment of the disclosure, the wearing member 312 may include a first area 3121 connected to the lens frame 311. Although the first area 3121 is described as a portion of the wearing member 312 in this document, this is optional. For example, in an embodiment of the disclosure, first area 3121 may be interpreted as a part of the lens frame 311.

According to an embodiment of the disclosure, the wearing member 312 may include a second area 3122 configured to move relative to the first area 3121. The second area 3122 may slide so that the length of the wearing member 312 and/or the length of the housing 310 may vary. A change in the length of the wearing member 312 may cause the size of the electronic device 200 to appropriately change to conform to the user's body, thereby improving the user's wearing comfort. The movement of the second area 3122 relative to the first area 3121 may be referred to as a change in the length of the wearing member 312 and/or housing 310.

According to an embodiment of the disclosure, the second area 3122 may move relative to the first area 3121, based on rotation of the wheel 330. The length of the second area 3122 exposed to the outside of the electronic device 300 (e.g., the size and/or length thereof inserted into a cover part 3123) may vary based on the rotation of the wheel 330. For example, if the wheel 330 rotates clockwise, the second area 3122 may move in a first direction (e.g., the +X direction), and if the wheel 330 rotates counterclockwise, the second area 3122 may move in a second direction (−X direction) opposite the first direction.

According to an embodiment of the disclosure, the wearing member 312 may include a cover part 3123 configured to guide the movement of the second area 3122. The cover part 3123 may cover at least a portion (e.g., an end of the first area 3121 and/or an end of the second area 3122) of the wearing member 312. According to an embodiment of the disclosure, the cover part 3123 may include an outer side wall 3123a covering at least a portion of the second area 3122. The second area 3122 may move in a first direction (+X direction) or a second direction (−X direction) along the outer side wall 3123a. According to an embodiment of the disclosure, the cover part 3123 may cover at least a portion of the wheel 330. For example, the cover part 3123 may include a hole through which a wheel area 332 of the wheel 330 is exposed to the outside of the electronic device 300. According to an embodiment of the disclosure, the cover part 3123 may be excluded or integrally formed with a portion (e.g., the first area 3121) of the housing 310.

According to an embodiment of the disclosure, the second area 3122 may be provided with force by the wheel 330. For example, the second area 3122 may include a first side wall 3122a and a second side wall 3122b configured to come into contact with the wheel 330. For example, the wheel area 332 may move in a first direction (+X direction). If the wheel area 332 moves in the first direction (+X direction), the first side wall 3122a of the second area 3122 may receive force from the wheel area 332. As the first side wall 3122a receives force, the second area 3122 may move in the first direction (+X). For example, the wheel area 332 may move in the second direction (−X direction). When the wheel area 332 moves in the second direction (−X direction), the second side wall 3122b of the second area 3122 may receive force from the wheel area 332. As the second side wall 3122b receives force, the second area 3122 may move in the second direction (−X). The first side wall 3122a may be arranged substantially parallel to the second side wall 3122b.

According to an embodiment of the disclosure, the sliding distance of the wearing member 312 may vary based on the distance between the first side wall 3122a and the second side wall 3122b. In an embodiment of the disclosure, the first side wall 3122a and the second side wall 3122b may be spaced apart by about 30 mm, and the length to which the wearing member 312 is changed may be within a range of 30 mm.

According to an embodiment of the disclosure, the second area 3122 may include at least one third side wall 3122c. According to an embodiment of the disclosure, the third side wall 3122c may be substantially perpendicular to the first side wall 3122a or the second side wall 3122b. The third side wall 3122c may be covered by a portion (e.g., the outer side wall 3123b) of the cover part 3123. Since at least a portion of the third side wall 3122c is surrounded by the cover part 3123, separation of the second area 3122 may be prevented or reduced.

According to an embodiment of the disclosure, the electronic device 200 may include a hinge (not shown) connected to the wearing member 312 and the lens frame 311. The wearing member 312 may be rotatable to the lens frame 311 using the hinge.

According to an embodiment of the disclosure, the input structure 320 may include a wheel 330 for adjusting the length of the housing 310. According to an embodiment of the disclosure, the wheel 330 may include a column part 331 and a wheel area 332. The column part 331 may be connected to the wearing member 312. For example, a first end 331a of the column part 331 may be connected to the first area 3121, and a second end 331b opposite the first end 331a may be connected to the second area 3122. The column part 331 may include a screw thread for guiding rotation of the wheel 330.

According to an embodiment of the disclosure, the wheel area 332 may rotate and/or move along the column part 331. For example, the wheel area 332 may move in a first direction (+X direction) or a second direction (−X direction) along a screw line formed in the column part 331. The wheel area 332 may transmit force to a part (e.g., the second area 3122) of the wearing member 312. For example, the wheel area 332 may come into contact with the first side wall 3122a or the second side wall 3122b of the second area 3122. At least a portion of the wheel area 332 may be exposed to the outside of the electronic device 300. The wheel 330 may be rotated based on a user input (e.g., rotation using a finger).

According to an embodiment of the disclosure, the input structure 320 may include an elastic member 321 to prevent or reduce an unintended length change of the wearing member 312. The elastic member 321 may provide force (e.g., elastic force) to the second area 3122. For example, the elastic member 321 may be positioned between the first area 3121 and the second area 3122 (e.g., the first side wall 3122a). The elastic member 321 may be a spring.

According to an embodiment of the disclosure, when the length of the elastic member 321 is reduced (e.g., when the length of the second area 3122 exposed from the cover part 3123 is reduced), the elastic member 321 may provide force to the first side wall 3122a. When a force greater than the elastic force provided by the elastic member 321 is provided to the input structure 320 due to rotation of the wheel 330 by the user, the second area 3122 may move in the first direction (+X direction). If no force is provided from the user, force for movement of the second area 3122 in the second direction (−X direction) (e.g., frictional force between the wheel area 332 and the column part 331) may be greater than the elastic force of the elastic member 321. According to an embodiment of the disclosure, the elastic member 321 may surround at least a portion of the column part 331. According to an embodiment of the disclosure, the elastic member 321 may be replaced with a stopper structure.

According to an embodiment of the disclosure, the shape of the housing 310 may be selectively designed. For example, the lengths or shapes of the lens frame 311 and/or the wearing member 312 may vary based on the design of the electronic device 300.

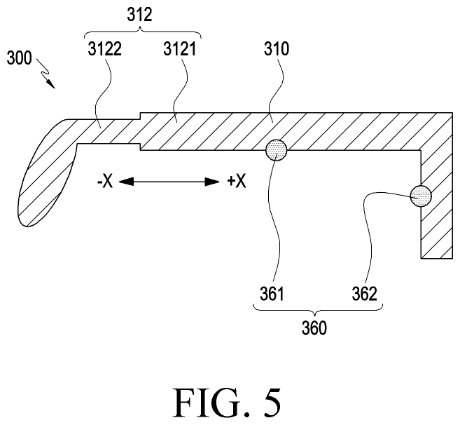

FIG. 5 is a diagram illustrating length adjustment of a housing based on a wearing sensor according to an embodiment of the disclosure.

Referring to FIG. 5, the electronic device 300 may include a housing 310 and a wearing detection sensor 360. The configurations of the housing 310 in FIG. 5 may be the same as all or some of the configurations of the housing 310 in FIG. 3, and the configurations of the wearing detection sensor 360 in FIG. 5 may be the same as all or some of the configurations of the sensor device 115 in FIG. 1.

According to an embodiment of the disclosure, the wearing detection sensor 360 may detect whether or not the electronic device 300 is worn on the user's body (e.g., head). For example, the wearing detection sensor 360 may include an optical sensors (e.g., infrared sensors) and/or proximity sensors. The wearing detection sensor 360 may be positioned inside the housing 310 or on the housing 310. The wearing detection sensor 360 may detect whether or not the electronic device 300 is worn at a plurality of points. For example, the wearing detection sensor 360 may include a first wearing detection sensor 361 and a second wearing detection sensor 362 spaced apart from the first wearing detection sensor 361.

According to an embodiment of the disclosure, a processor (e.g., the processor 111 in FIG. 1) may determine whether or not the electronic device 300 is worn based on a signal detected by the wearing detection sensor 360. According to an embodiment of the disclosure, if it is determined that the electronic device 300 is worn on the user's body (e.g., head), the processor 111 may adjust the length pf the housing 310 using a length adjusting structure (e.g., a motor and/or an actuator). Adjustment of the length of the housing 310 (or wearing member 312) performed by the processor 111 may be referred to as automatic length adjustment. For example, the electronic device 300 may include a motor and/or an actuator for rotating a wheel (e.g., the wheel 330 in FIGS. 3, 4A, and/or 4B) or moving the second area 3122. The processor 111 may produce a signal for driving the motor and/or actuator, based on the signal and/or data detected by the wearing detection sensor 360.

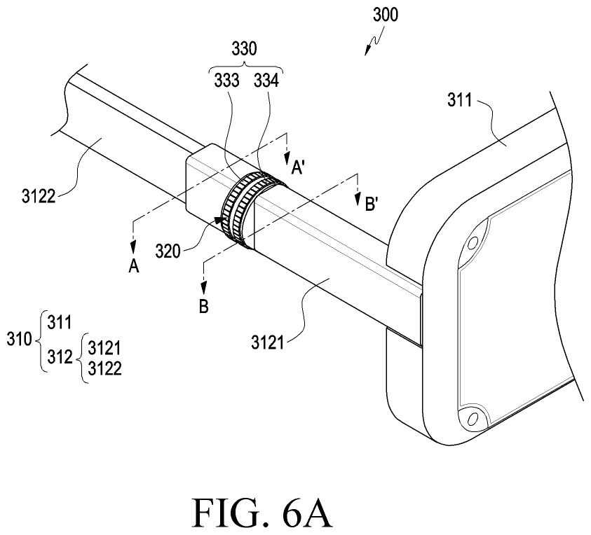

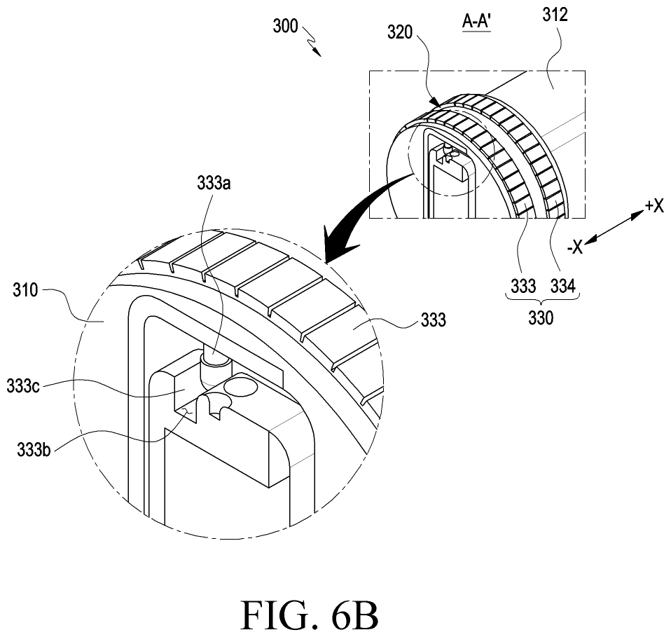

FIG. 6A is a perspective view of an electronic device including a first wheel and a second wheel according to an embodiment of the disclosure.

FIGS. 6B and 6C are diagrams illustrating an internal structure of an electronic device including a first wheel and a second wheel according to various embodiments of the disclosure.

Referring to FIGS. 6A, 6B, and/or 6C, the electronic device 300 may include a housing 310 and a wheel 330. The configurations of the electronic device 300, the housing 310, and the wheel 330 in FIGS. 6A, 6B, and/or 6C may be the same as all or some of the configurations of the electronic device 300, the housing 310, and the wheel 330 in FIGS. 3, 4A, and/or 4B. The structure (e.g., a first wheel 333 and a second wheel 334) of the electronic device 300 shown in FIGS. 6A, 6B, and/or 6C may be used together with other embodiments disclosed herein.

According to an embodiment of the disclosure, the wheel 330 may include a plurality of wheels 333 and 334. For example, the wheel 330 may include a first wheel 333 and a second wheel 334. The second wheel 334 may be positioned substantially parallel to the first wheel 333.

According to an embodiment of the disclosure, the first wheel 333 may implement the movement of the wearing member 312. For example, based on rotation of the first wheel 333, the second area 3122 of the wearing member 312 may move relative to the first area 3121. According to an embodiment of the disclosure, the configurations of the first wheel 333 may be the same as all or some of the configurations of the wheel 330 shown in FIG. 3, 4A, or 4B.

According to an embodiment of the disclosure, the input structure 320 may include a protrusion 333a connected to the first wheel 333 and a stopper 333b for restricting movement of the protrusion 333a. The stopper 333b may prevent or reduce an unintended length change of the wearing member 312. For example, the stopper 333b may prevent or reduce the movement of the protrusion 333a and/or the first wheel 333 when force equal to or greater than a specified level is not transferred to the first wheel 333.

According to an embodiment of the disclosure (e.g., FIG. 6B), the input structure 320 may include a rail part 333c for guiding a path of movement of the second area 3122. For example, the second area 3122 may move relative to the first area 3121 along the rail part 333c.

The structure of the input structure 320 for implementing the movement of the wearing member 312 may be optional. For example, the structure of the input structure 320 may be applied to the electronic device 300 without limitation as long as the second area 3122 is able to move relative to the first area 3121 based on the rotation of the first wheel 333.

According to an embodiment of the disclosure (e.g., FIG. 6C), the second wheel 334 may detect a user input for performing a specified operation. For example, the electronic device 300 includes a rotation detection sensor 340 for detecting the rotation direction, rotation number, and/or rotation speed of at least some (e.g., the second wheel 334) of the wheels 330. According to an embodiment of the disclosure, the rotation detection sensor 340 may be an ultrasonic sensor, a laser sensor, a power generation sensor, and/or an encoder for detecting rotation of the second wheel 334. For example, the second wheel 334 may detect a user's gesture for performing a specified operation.

According to an embodiment of the disclosure, the electronic device 300 may include a substrate 341 accommodating the rotation detection sensor 340. The substrate 341 may be electrically connected to a processor of the disclosure (e.g., the processor 111 in FIG. 1).

According to an embodiment of the disclosure, the processor 111 may perform a specified operation, based on a user input detected by the rotation detection sensor 340. For example, the processor 111 may execute a specified program stored in a memory (e.g., the memory 112 in FIG. 1), based on a gesture detected by the rotation detection sensor 340.

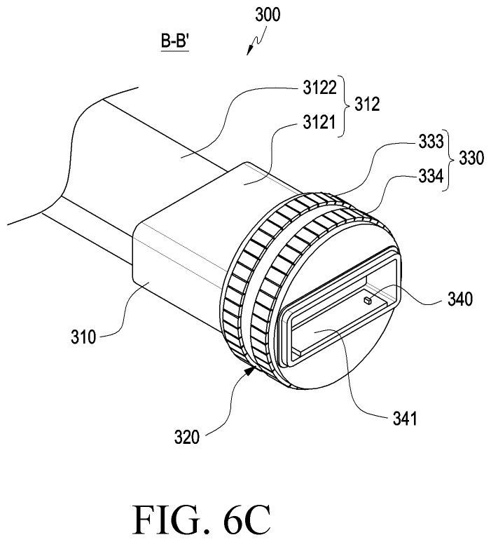

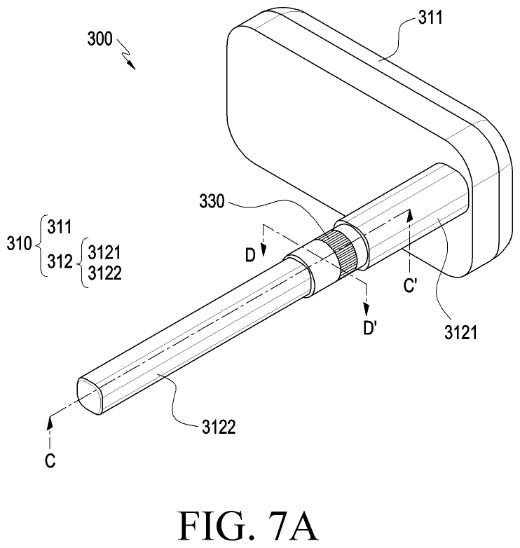

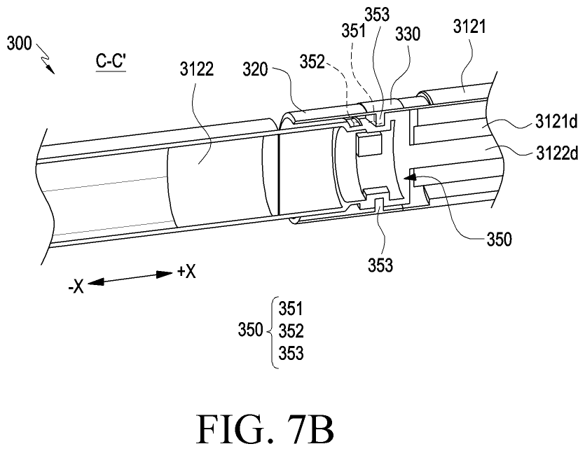

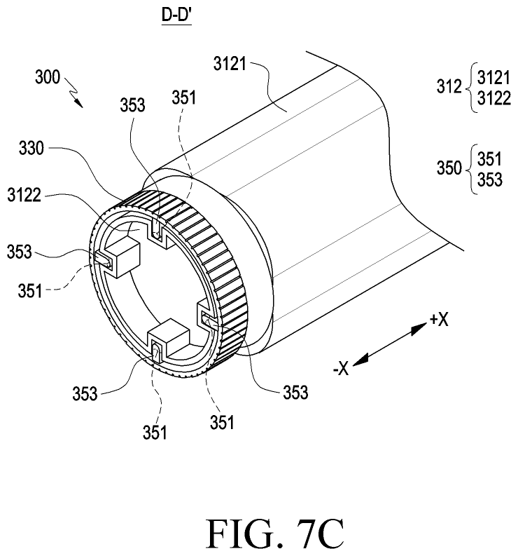

FIG. 7A is a perspective view of an electronic device including a clutch structure according to an embodiment of the disclosure.

FIG. 7B is a cross-sectional perspective view taken along line C-C′ in FIG. 7A according to an embodiment of the disclosure.

FIGS. 7C and 7D are cross-sectional perspective views taken along line D-D′ in FIG. 7A according to various embodiments of the disclosure.

Referring to FIGS. 7A, 7B, 7C, and 7D, the electronic device 300 may include a housing 310, a wheel 330, and a clutch structure 350. The configurations of the electronic device 300, the housing 310, and the wheel 330 in FIGS. 7A, 7B, 7C, and/or 7D may be the same as all or some of the configurations of the electronic device 300, the housing 310, and the wheel 330 in FIG. 3. The structure (e.g., the clutch structure 350) of the electronic device 300 shown in FIGS. 7A, 7B, 7C, and/or 7D may be used together with other embodiments disclosed in this document.

According to an embodiment of the disclosure, the clutch structure 350 may implement different operations using one wheel 330. For example, the clutch structure 350 may change the length of the wearing member 312 or perform a specified operation, based on the rotation of one wheel 330. According to an embodiment of the disclosure, the clutch structure 350 may change a structure to which the wheel 330 is connected. An operation of the electronic device 300 corresponding to the rotation of the wheel 330 may vary based on the structure to which the wheel 330 is connected.

According to an embodiment of the disclosure, the clutch structure 350 may include at least one first receiving groove 351 and a second receiving groove 352 spaced apart from the first receiving groove 351. The first receiving groove 351 may have a shape for rotating both the wheel 330 and the second area 3122 of the wearing member 312. For example, the first receiving groove 351 may be at least one groove formed in the second area 3122. The second receiving groove 352 may accommodate a protrusion 353 to be movable. For example, the second receiving groove 352 may be a ring-shaped groove.

According to an embodiment of the disclosure, the clutch structure 350 may include a protrusion 353. The protrusion 353 may be inserted into the first receiving groove 351 or the second receiving groove 352 according to the movement of the clutch structure 350. The protrusion 353 may be a portion of the wheel 330 protruding from the inner surface of the wheel 330. According to an embodiment of the disclosure, the protrusion 353 may be integrally formed with the wheel 330.

According to an embodiment of the disclosure, the wheel 330 may move along a first direction (+X direction) or a second direction (−X direction). The position of the protrusion 353 may vary based on the movement of the wheel 330. In the state in which the protrusion 353 is positioned in the first receiving groove 351 (e.g., FIG. 7C), at least a portion (e.g., the second area 3122) of the wearing member 312 may move based on the rotation of the wheel 330. For example, the wheel 330 may rotate together with the second area 3122. According to an embodiment of the disclosure, the second area 3122 may include an extension 3122d inserted into a screw groove 3121d of the first area 3121. The wheel 330 may rotate with respect to the first area 3121 and the second area 3122 in the state where the protrusion 353 is positioned in the second receiving groove 352 (e.g., FIG. 7D). For example, the wheel 330 may rotate separately from the second area 3122. The state in which the protrusion 353 is positioned in the second receiving groove 352 may be referred to as a free wheel state. According to an embodiment of the disclosure, a rotation detection sensor (e.g., the rotation detection sensor 340 in FIG. 6C) of the electronic device 300 may detect rotation of the wheel 330 configured to rotate in the second receiving groove 352.

According to an embodiment of the disclosure, a processor (e.g., the processor 111 in FIG. 1) may move at least a part of the clutch structure 350. For example, the electronic device 300 may include a driving structure (e.g., a motor and/or an actuator) capable of moving the wheel 330 and/or the protrusion 353, and the processor 111 may move the wheel 330 and/or the protrusion 353 in the first direction (+X direction) or the second direction (−X direction) using the driving structure.

According to an embodiment of the disclosure, the electronic device 300 may move the clutch structure 350 using a wearing detection sensor (e.g., the wearing detection sensor 360 in FIG. 5). For example, the clutch structure 350 may move based on whether or not the user wears the electronic device 300. According to an embodiment of the disclosure, if it is determined that the electronic device 300 is worn on the user's body using the wearing detection sensor 360, the processor 111 may move the wheel 330 and/or the protrusion 353 such that the protrusion 353 is positioned in the second receiving groove 352. If it is determined that the electronic device 300 is worn on the user's body using the wearing detection sensor 360, the processor 111 may move the wheel 330 and/or the protrusion 353 such that the protrusion 353 is positioned in the first receiving groove 351. According to an embodiment of the disclosure, if it is determined that the electronic device 300 is worn on the user's body, in order to bring the electronic device 300 into close contact with the user's body, the processor 111 may move the wheel 330 and/or protrusion 353 such that the protrusion 353 is positioned in the first receiving groove 351, and then move the wheel 330 and/or protrusion 353 such that the protrusion 353 is positioned in the second receiving groove 352.

According to an embodiment of the disclosure, the state in which the protrusion 353 is positioned in the first receiving groove 351 may be referred to as a length adjustment state or a first state. The state in which the protrusion 353 is positioned in the second receiving groove 352 may be referred to as a fixed state, an operating state, or a second state.

According to an embodiment ‘of the disclosure, the electronic device 300 may include an input device (e.g., the input/output device 113 in FIG. 1) for detecting a user input. The processor 111 may move at least a part of the clutch structure 350, based on the user input detected by the input device. The input device may be a button exposed to the outside of the housing 310. According to an embodiment of the disclosure, the position of wheel 330 and/or protrusion 353 may be manually changed.

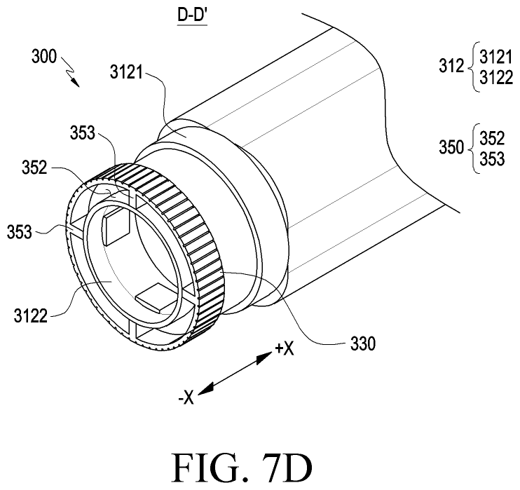

FIG. 8 is a cross-sectional perspective view of an electronic device including a motor module according to an embodiment of the disclosure.

Referring to FIG. 8, an electronic device 300 may include a lens frame 311, a wearing member 312, a wheel 330, and a driving structure 370.

The configurations of the electronic device 300, the lens frame 311, the wearing member 312, and the wheel 330 in FIG. 8 may be the same as all or some of the configurations of the electronic device 300, the lens frame 311, the wearing member 312, and the wheel 330 in FIG. 3. The structure of the electronic device 300 shown in FIG. 8 may be used together with other embodiments disclosed in this document. The wheel 330 may be positioned on at least one of a first wearing member 312a or a second wearing member 312b.

According to an embodiment of the disclosure, the electronic device 300 may be designed asymmetrically. For example, the electronic device 300 includes a lens frame 311, a first wearing member 312a connected to one end of the lens frame 311, and a second wearing member 312b spaced apart from the first wearing member 312a. The second wearing member 312b may be disposed substantially parallel to the first wearing member 312a.

According to an embodiment of the disclosure, the components disposed inside the first wearing member 312a may be different from the components disposed inside the second wearing member 312b. For example, the wheel 330 may be disposed on one wearing member (e.g., the first wearing member 312a) and may not be disposed on the other wearing member (e.g., the second wearing member 312b).

According to an embodiment of the disclosure, the electronic device 300 may include a driving structure 370 for moving a wearing member (e.g., the second wearing member 312b) on which the wheel 330 is not disposed. The driving structure 370 may include a motor 371 and a gear structure 372 for moving a part (e.g., the second area 3122) of the second wearing member 312b using the driving force produced by the motor 371.

According to an embodiment of the disclosure, a processor (e.g., the processor 111 in FIG. 1) may produce a signal for driving a wearing member (e.g., the second wearing member 312b) where the wheel 330 is not positioned, based on information obtained from the wheel 330. For example, the processor 111 may detect a user input using the wheel 330 connected to the first wearing member 312a. The processor 111 may determine a rotation value (e.g., a rotation angle and/or rotation speed) of the wheel 330. The processor 111 may operate the driving structure 370, based on the detected user input. For example, the processor 111 may determine a distance value of the first wearing member 312a corresponding to the rotation value of the wheel 330 and may move the second wearing member 312b such that second wearing member 312b moves a distance by which the first wearing member 312a moved.

According to an embodiment of the disclosure, the length of the first wearing member 312a (e.g., movement of the second area 3122 relative to the first area 3121) may vary due to rotation of the wheel 330. For example, the second area 3122 may move in a first direction (+X direction) or a second direction (−X direction), based on rotation of the wheel 330. According to an embodiment of the disclosure, the second wearing member 312b may change due to the operation of the driving structure 370. For example, the second area 3122 of the second wearing member 312b may move in the first direction (+X direction) or the second direction (−X direction), based on the gear structure 372 that moves based on the driving force produced by the motor 371.

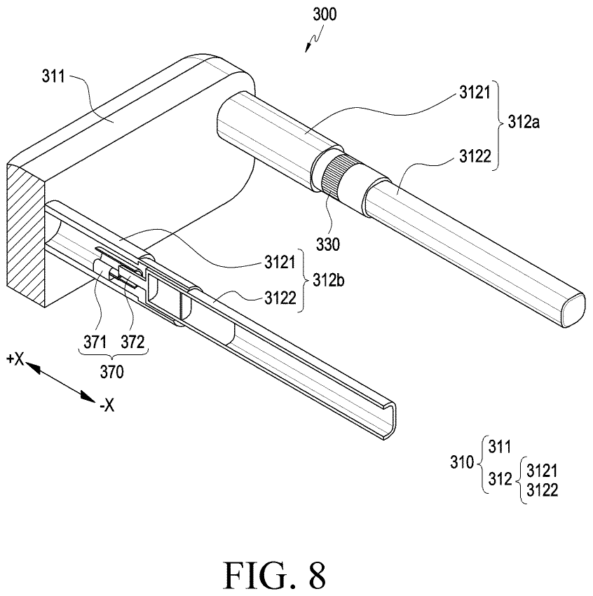

FIG. 9 is a perspective view of an electronic device including a touch pad structure according to an embodiment of the disclosure.

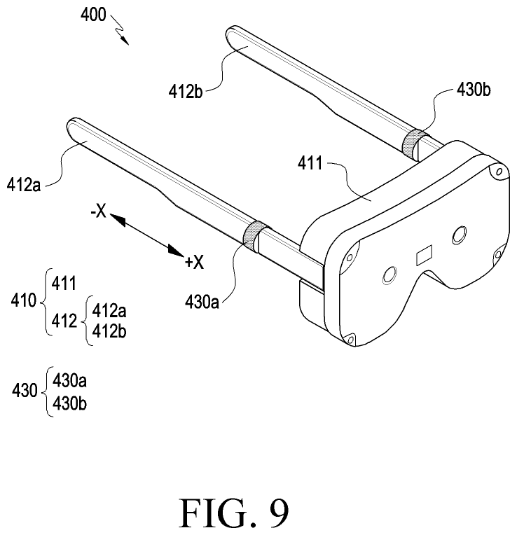

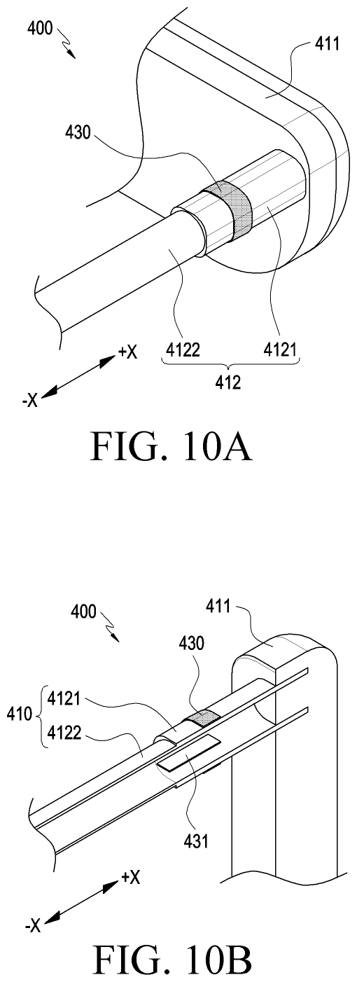

FIG. 10A is an enlarged view of an electronic device including a touch pad structure according to an embodiment of the disclosure.

FIG. 10B is a cross-sectional perspective view of an electronic device including a touch pad structure according to an embodiment of the disclosure.

Referring to FIGS. 9, 10A, and 10B, an electronic device 400 may include a housing 410 including a lens frame 411 and a wearing member 412, and a wheel 430. The configurations of the electronic device 400, the housing 410, and the wheel 430 in FIGS. 9, 10A, and/or 10B may be the same as all or some of the configurations of the electronic device 300, the housing (e.g., the lens frame 311 and the wearing member 312), and the wheel 330 in FIG. 3.

According to an embodiment of the disclosure, the wheel 430 may include a virtual wheel detected in a touch pad module. For example, the wheel 430 may be a display module including a touch pattern, and the electronic device 400 may detect capacitance using the wheel 430, thereby detecting a user's gesture. According to an embodiment of the disclosure, the electronic device 400 may detect various gestures. For example, the processor 111 may perform various operations using pressure applied to the wheel 430 and/or the number of inputs close to the wheel 430 (e.g., detecting a change in capacitance at a plurality of points). For example, the processor 111 may implement a selection interaction using a specified operation.

According to an embodiment of the disclosure, the electronic device 400 may adjust the position of the wearing member 412 relative to the lens frame 411 using the wheel 430. For example, a processor (e.g., the processor 111 in FIG. 1) may operate a driving structure (e.g., the driving structure 370 in FIG. 8), based on a result detected in the wheel 430. A portion (e.g., a second area 4122) of the wearing member 412 may move relative to the lens frame 411 and/or another portion (e.g., a first area 4121) of the wearing member 412 by the driving structure 370.

According to an embodiment of the disclosure, the electronic device 400 may perform a specified operation using the wheel 430. For example, the processor 111 may perform a specified operation, based on a signal obtained using an input structure (e.g., the wheel 430). The specified operation may be implemented using data stored in a memory (e.g., the memory 112 in FIG. 1).

According to an embodiment of the disclosure, the electronic device 300 may include a plurality of wheels 430. For example, the electronic device 400 may include a first wheel 430a connected to the first wearing member 412a and a second wheel 430b connected to the second wearing member 412b. According to an embodiment of the disclosure, at least one of the first wheel 430a or the second wheel 430b may change the length of the wearing member 412. According to an embodiment of the disclosure, the electronic device 400 may perform a specified operation using at least one of the first wheel 430a or the second wheel 430b. According to an embodiment of the disclosure, the first wheel 430a may perform a different operation from that of the second wheel 430b. For example, the first wheel 430a may be a configuration for changing the length of the wearing member 412, and the second wheel 430b may be a configuration for performing a specified operation (e.g., volume control and/or menu selection) of the electronic device 400.

The structure (e.g., the wheel 430) of the electronic device 400 shown in FIGS. 9, 10A, and/or 10B may be used together with other embodiments disclosed in this document. For example, the electronic device 400 may include the wheel (e.g., a virtual wheel) 430 in FIGS. 9, 10A, and/or 10B as well as the physical wheel 330.

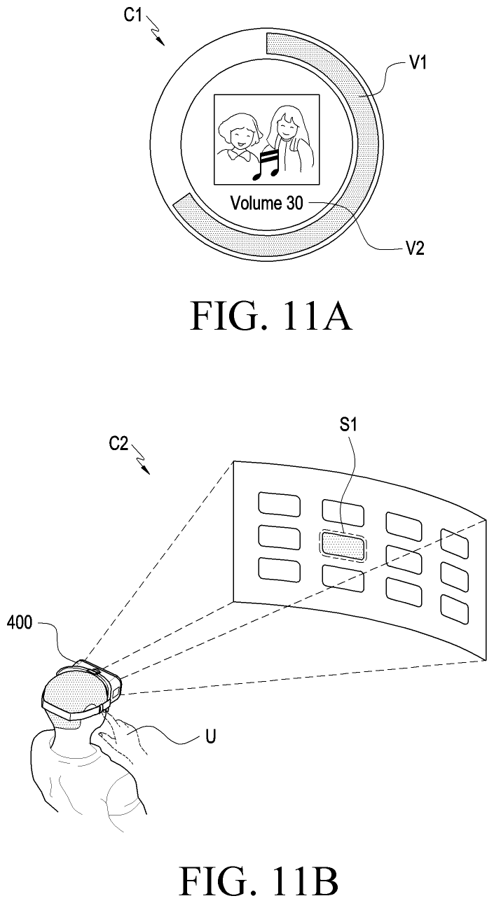

FIGS. 11A and 11B are diagrams illustrating the operation of an electronic device including an input structure according to an embodiment of the disclosure.

Referring to FIGS. 11A and 11B, a processor (e.g., the processor 111 in FIG. 1) of an electronic device (e.g., the electronic device 300 in FIG. 3 and/or the electronic device 400 in FIG. 9) may perform a specified operation using an input structure (e.g., the wheel 330 in FIG. 3 or the wheel 430 in FIGS. 10A and 10B).

According to an embodiment of the disclosure, the electronic device 400 may perform various specified operations using the wheels 330 and 430. For example, the specified operations may include adjusting sound of the electronic device 400, adjusting magnification of an image (e.g., zooming in and/or zooming out) output from the electronic device 400, and/or selecting some of the menus output from the electronic device 400. However, the specified operations described in this disclosure are provided by way of example and are not specifically limited as long as they may be performed in the electronic device 400 using the wheels 330 and 430.

According to an embodiment of the disclosure (e.g., FIG. 11A), the electronic device 400 may provide content C1 for adjusting sound output from the electronic device 400. The content C1 may be provided to the user using a display module (e.g., the display module 240 in FIG. 2).

According to an embodiment of the disclosure, based on the rotation of the wheel 330, the processor 111 may change the volume of sound output from the speaker (e.g., the input/output device 113 in FIG. 1) of the electronic device 300. According to an embodiment of the disclosure, the electronic device 300 may display information reflecting the current volume of sound to the user through a first image V1 in the form of a graph and a second image V2 in the form of a letter.

According to an embodiment of the disclosure (e.g., FIG. 11B), the electronic device 400 may provide content C2 for selecting some information from among information displayed on the electronic device 400. For example, the processor 111 may select a partial area S1 of an image output from the display module 240, based on a gesture transmitted by the user U to the wheel 330.

A wearable electronic device may be worn on a user's body. However, since the size of a user's body may differ, if the size of the electronic device is constant, the wearing comfort of a user may be reduced. According to an embodiment of the disclosure, the electronic device may change the length of the wearing member using a wheel. Changing the length of the wearing member may improve the user's wearing comfort. According to an embodiment of the disclosure, an electronic device for performing a specified operation using a wheel may be provided.

The issues to be addressed in the disclosure are not limited to the above-mentioned problems and may be expanded in various ways without departing from the spirit and scope of the disclosure.

According to an embodiment of the disclosure, a wearable electronic device (e.g., the electronic device 200 in FIG. 2) may include a housing (e.g., the housing 210 in FIG. 2) including a lens frame (e.g., the lens frame 211 in FIG. 2) accommodating a transparent member (e.g., the transparent member 201 in FIG. 2), and a wearing member (e.g., the wearing member 212 in FIG. 2) having at least a portion thereof configured to move relative to the lens frame, a processor (e.g., the processor 111 in FIG. 1) positioned inside the housing, and an input structure (e.g., the input structure 320 in FIG. 3) including a wheel (e.g., the wheel 330 in FIG. 3) configured to adjust position of the wearing member with respect to the lens frame. The processor may be configured to perform a specified operation, based on a signal obtained using the input structure.

According to an embodiment of the disclosure, the wearing member may include a first area (e.g., the first area 3121 in FIG. 3) connected to the lens frame, a second area (e.g., the second area 3122 in FIG. 3) configured to move relative to the first area, based on rotation of the wheel, and a cover part (e.g., the cover part 3123 in FIG. 3) covering at least a portion of the wheel and configured to guide sliding movement of the second area.

According to an embodiment of the disclosure, the wheel may include a column part (e.g., the column part 331 in FIG. 4B) connected to the first area and the second area, and a wheel area (e.g., the wheel area 332 in FIG. 4B) configured to rotate about the column part and having at least a portion thereof exposed to the outside of the wearable electronic device. The wheel area may be configured to transfer force to the second area. For example, the wheel area may transfer force to the second area so that the second area may move relative to the first area.

According to an embodiment of the disclosure, the input structure may include an elastic member (e.g., the elastic member in FIG. 4B) surrounding the column part and positioned between the first area and the second area. The elastic force of the elastic member may reduce a change in length of the wearing member, which is not intended by the user.

According to an embodiment of the disclosure, the second area may include a first side wall (e.g., the first side wall 3122a in FIG. 4B) and a second side wall (e.g., the second side wall 3122b in FIG. 4B) arranged parallel to the first side wall. The wheel area may be configured to be in contact with the first side wall or the second side wall. As the wheel area come into contact with the first side wall or the second side wall, the user's force applied to the wheel may be used to move the second area.

According to an embodiment of the disclosure, the wearable electronic device may further include a rotation detection sensor (e.g., the rotation detection sensor 340 in FIG. 6C) configured to detect rotation of the wheel. The processor may perform a specified operation by the rotation detection sensor.

According to an embodiment of the disclosure, the wheel may include a first wheel (e.g., the first wheel 333 in FIG. 6A) configured to move the wearing member and a second wheel (e.g., the second wheel 334 in FIG. 6A) configured to detect a user input. The rotation detection sensor may be configured to detect rotation of the second wheel.

According to an embodiment of the disclosure, the wearable electronic device may include a clutch structure (e.g., the clutch structure 350 in FIG. 7B) that includes at least one first receiving groove (e.g., the first receiving groove 351 in FIG. 7B) formed in the housing, a ring-shaped second receiving groove (e.g., the second receiving groove 352 in FIG. 7B) spaced apart from the first receiving groove, and a protrusion (e.g., protrusion 353 in FIG. 7B) extending from the wheel and configured to be inserted into the first receiving groove or the second receiving groove.

According to an embodiment of the disclosure, the wheel may rotate together with at least a portion of the wearing member in a state in which the protrusion is inserted into the first receiving groove. The wheel may be configured to rotate with respect to the wearing member in a state in which the protrusion is inserted into the second receiving groove. As the wheel rotates together with at least a portion of the wearing member in the state in which the wheel is inserted into the first receiving groove, a length of the wearing member may vary. As the wheel rotates with respect to the wearing member in the state in which the wheel is inserted into the second receiving groove, the wearing detection sensor may detect the rotation of the wheel, and the processor may perform a specified operation.

According to an embodiment of the disclosure, the wearable electronic device may further include a wearing detection sensor (e.g., the wearing detection sensor 360 in FIG. 5) configured to detect wearing of the wearable electronic device on a user. The processor may produce a signal for moving the wearing member, based on whether or not the wearable electronic device is worn, which is detected using the wearing detection sensor.

According to an embodiment of the disclosure, the wearing member may include a first wearing member (e.g., the first wearing member 312a in FIG. 9) and a second wearing member (e.g., the second wearing member 312b in FIG. 9) spaced apart from the first wearing member. The wheel may be positioned inside the first wearing member. The input structure may include a rotation detection sensor (e.g., the rotation detection sensor 340 in FIG. 6C) positioned inside the first wearing member and configured to detect rotation of the wheel, and a driving structure (e.g., the driving structure 370 in FIG. 8) positioned inside the second wearing member.

According to an embodiment of the disclosure, the wheel may include a virtual wheel provided using a touch pad module.

According to an embodiment of the disclosure, a drive structure (e.g., the driving structure 370 in FIG. 8) configured to move at least a portion of the wearing member may be further included. The processor may be configured to control the driving structure, based on a user input obtained from the touch pad module.

According to an embodiment of the disclosure, the specified operation may include adjusting the volume of sound output from the wearable electronic device, adjusting the magnification of an image output from the wearable electronic device, or selecting at least one menu output from the wearable electronic device.

According to an embodiment of the disclosure, the wearing member may be configured to move along a first direction (e.g., the +X direction in FIG. 3) or a second direction (e.g., the −X direction in FIG. 3) opposite the first direction. The wheel may be configured to rotate about a first axis (e.g., the X axis in FIG. 3) forming the first direction or the second direction.

According to an embodiment of the disclosure, the wearable electronic device may include a display module (e.g., the display module 240 in FIG. 2) configured to output an image to the transparent member, a circuit board (e.g., the circuit board 241 in FIG. 2) accommodating the processor, and a battery (e.g., the battery 243 in FIG. 2) configured to supply power to the processor and the display module.

According to an embodiment of the disclosure, an electronic device (e.g., the electronic device 200 in FIG. 2) may include a housing (e.g., the housing 310 in FIG. 3) including a lens frame (e.g., the lens frame 211 in FIG. 2) and a wearing member (e.g., the wearing member 212 in FIG. 2) having at least a portion thereof configured to move relative to the lens frame, a processor (e.g., the processor 111 in FIG. 1) positioned inside the housing, a wheel (e.g., the wheel 330 in FIG. 3) configured to adjust position of the wearing member with respect to the lens frame, and a rotation detection sensor (e.g., the rotation detection sensor 340 in FIG. 6C) disposed inside the wearing member and configured to detect rotation of the wheel. The wearing member may include a first area (e.g., the first area 3121 in FIG. 3) connected to the lens frame and a second area (e.g., the second area 3122 in FIG. 3) configured to move relative to the first area, based on rotation of the wheel. The wheel may include a column part (e.g., the column part 331 in FIG. 4B) connected to the first area and the second area, and a rotation area (e.g., the rotation area 332 in FIG. 4B) configured to rotate about the column part and transmit force to the second area. The processor may be configured to perform a specified operation, based on rotation of the wheel.

According to an embodiment of the disclosure, the electronic device may further include an elastic member (e.g., the elastic member 321 in FIG. 4B) surrounding the column part and positioned between the first area and the second area.

According to an embodiment of the disclosure, the wheel may include a first wheel (e.g., the first wheel 333 in FIG. 6A) configured to move the wearing member and a second wheel (e.g., the second wheel 334 in FIG. 6A) configured to be detected by the rotation detection sensor.

According to an embodiment of the disclosure, the electronic device may further include a clutch structure (e.g., the clutch structure 350 in FIG. 7B) that includes at least one first receiving groove (e.g., the first receiving groove 351 in FIG. 7B) formed in the housing, a ring-shaped second receiving groove (e.g., the second receiving groove 352 in FIG. 7B) spaced apart from the first receiving groove, and a protrusion (e.g., the protrusion 353 in FIG. 7B) extending from the wheel and configured to be inserted into the first receiving groove or the second receiving groove.

According to an embodiment of the disclosure, the wheel may be configured to rotate together with at least a portion of the wearing member in a state in which the protrusion is inserted into the first receiving groove. The wheel may be configured to rotate with respect to the wearing member in a state in which the protrusion is inserted into the second receiving groove.

The wearable electronic device including the input structure of the disclosure described above is not limited to the above-described embodiments and drawings, and it will be obvious to those skilled in the art to which the disclosure pertains that various substitutions, modifications, and changes are possible within the technical scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a housing including:
a lens frame accommodating a transparent member, and
a wearing member having at least a portion thereof configured to move relative to the lens frame;
a processor positioned inside the housing; and
an input structure including a wheel configured to adjust position of the wearing member with respect to the lens frame,
wherein the processor is configured to perform a specified operation, based on a signal obtained using the input structure.

2. The wearable electronic device of claim 1, wherein the wearing member comprises:
a first area connected to the lens frame;
a second area configured to move relative to the first area, based on rotation of the wheel; and
a cover part covering at least a portion of the wheel and configured to guide sliding movement of the second area.

3. The wearable electronic device of claim 2, wherein the wheel comprises:
a column part connected to the first area and the second area; and
a wheel area configured to rotate about the column part and having at least a portion thereof exposed to an area outside of the wearable electronic device, and
wherein the wheel area is configured to transfer force to the second area.

4. The wearable electronic device of claim 3, wherein the input structure comprises an elastic member surrounding the column part and positioned between the first area and the second area.

5. The wearable electronic device of claim 4,
wherein the second area comprises a first side wall and a second side wall arranged parallel to the first side wall, and
wherein the wheel area is configured to be in contact with the first side wall or the second side wall.

6. The wearable electronic device of claim 5, further comprising a rotation detection sensor configured to detect rotation of the wheel.

7. The wearable electronic device of claim 6, wherein the wheel comprises:
a first wheel configured to move the wearing member; and
a second wheel configured to be detected by the rotation detection sensor.

8. The wearable electronic device of claim 7, further comprising a clutch structure that comprises at least one first receiving groove formed in the housing, a ring-shaped second receiving groove spaced apart from the first receiving groove, and a protrusion extending from the wheel and configured to be inserted into the first receiving groove or the second receiving groove.

9. The wearable electronic device of claim 8,
wherein the wheel is configured to rotate together with at least a portion of the wearing member in a state in which the protrusion is inserted into the first receiving groove, and
wherein the wheel is configured to rotate with respect to the wearing member in a state in which the protrusion is inserted into the second receiving groove.

10. The wearable electronic device of claim 9, further comprising a wearing detection sensor configured to detect wearing of the wearable electronic device on a user,
wherein the processor is further configured to produce a signal for moving the wearing member, based on whether or not the wearable electronic device is worn, which is detected using the wearing detection sensor.

11. The wearable electronic device of claim 10,
wherein the wearing member comprises a first wearing member and a second wearing member spaced apart from the first wearing member,
wherein the wheel is positioned inside the first wearing member, and
wherein the input structure comprises a rotation detection sensor positioned inside the first wearing member and configured to detect rotation of the wheel, and a driving structure positioned inside the second wearing member.

12. The wearable electronic device of claim 11, wherein the wheel comprises a virtual wheel provided using a touch pad module.

13. The wearable electronic device of claim 12, further comprising a drive structure configured to move at least a portion of the wearing member,
wherein the processor is further configured to control the driving structure, based on a user input obtained from the touch pad module.

14. The wearable electronic device of claim 13, wherein the specified operation comprises adjusting the volume of sound output from the wearable electronic device, adjusting a magnification of an image output from the wearable electronic device, or selecting at least one menu output from the wearable electronic device.

15. The wearable electronic device of claim 14,
wherein the wearing member is configured to move along a first direction or a second direction opposite the first direction, and
wherein the wheel is configured to rotate about a first axis forming the first direction or the second direction.

16. An electronic device comprising:
a housing including a lens frame and a wearing member having at least a portion thereof configured to move relative to the lens frame;
a processor positioned inside the housing;
a wheel configured to adjust position of the wearing member with respect to the lens frame; and
a rotation detection sensor disposed inside the wearing member and configured to detect rotation of the wheel,
wherein the wearing member includes a first area connected to the lens frame and a second area configured to move relative to the first area, based on rotation of the wheel,
wherein the wheel includes a column part connected to the first area and the second area, and a rotation area configured to rotate about the column part and transmit force to the second area, and
wherein the processor is configured to perform a specified operation, based on rotation of the wheel.

17. The electronic device of claim 16, further comprising an elastic member surrounding the column part and positioned between the first area and the second area.

18. The electronic device of claim 16, wherein the wheel comprises:
a first wheel configured to move the wearing member; and
a second wheel configured to be detected by the rotation detection sensor.

19. The electronic device of claim 16, further comprising a clutch structure that comprises:
at least one first receiving groove formed in the housing,
a ring-shaped second receiving groove spaced apart from the first receiving groove, and
a protrusion extending from the wheel and configured to be inserted into the first receiving groove or the second receiving groove.

20. The electronic device of claim 19,
wherein the wheel is configured to rotate together with at least a portion of the wearing member in a state in which the protrusion is inserted into the first receiving groove, and
wherein the wheel is configured to rotate with respect to the wearing member in a state in which the protrusion is inserted into the second receiving groove.
